(19) United States
(12) Patent Application Publication
(10) Pub. No.: US 2023/0214462 A1
(43) Pub. Date: Jul. 6, 2023

(54) Creating Digital Autographs

(71) Applicant: Fifthpint, LLC, Austin, TX (US)

(72) Inventor: Robert Barth Black, Austin, TX (US)

(73) Assignee: Fifthpint, LLC, Austin, TX (US)

(21) Appl. No.: 18/113,999

(22) Filed: Feb. 24, 2023

Related U.S. Application Data
(63) Continuation of application No. 16/865,411, filed on May 3, 2020.
(60) Provisional application No. 62/842,865, filed on May 3, 2019.

(51) Int. Cl. G06F 21/31; G06Q 50/00

(52) U.S. Cl. CPC G06F 21/31; G06Q 50/01

(57) ABSTRACT

A system and method including determining a location of a creator's creator computing device and determining a location of a follower's follower computing device. Digital media is then customized to create customized digital media, based at least in part on an in-person interaction between the creator and the follower. The in-person interaction is based at least upon the location of the creator computing device and the location of the follower computing device. The customizing includes including the location of the creator computing device and the location of the follower computing device.

### A. PRIORITY CLAIM/INCORPORATION BY REFERENCE

This application is a continuation of and claims the benefit of

U.S. patent application Ser. No. 16,865,411, filed May 3, 2020, entitled “Creating Digital Autographs,” and naming Robert Barth Black as inventor, which claims the benefit of

U.S. Provisional Patent Application No. 62/842,865, filed May 3, 2019, entitled “Method for Creating and Tokenizing Digital Autographs with support for Digital Collectable Rewards,” and naming Robert Barth Black as inventor.

All of the above-referenced patent applications are hereby incorporated by reference herein in their entirety.

### B. BACKGROUND

The invention relates generally to autographs, and more particularly to digital autographs.

### C. BRIEF DESCRIPTION OF THE DRAWINGS

Other objects and advantages of the invention may become apparent upon reading the detailed description and upon reference to the accompanying drawings.

FIG. 1 is a block diagram illustrating a system configured to facilitate digital autographs, in accordance with some embodiments.

FIG. 2 is a block diagram illustrating components of a device used in digital autographs, in accordance with some embodiments.

FIG. 3 is a block diagram illustrating the digital signing of an autograph by multiple creators, in accordance with some embodiments.

FIG. 4 is a flow diagram illustrating a method for providing digital autographs, in accordance with some embodiments.

FIG. 5 is a flow diagram illustrating a creator to provide a digital autograph to a follower, in accordance with some embodiments.

FIG. 6 is a flow diagram illustrating a method for a follower to request an autograph from a creator, in accordance with some embodiments.

FIG. 7 is a flow diagram illustrating a method for a creator to digitally sign a digital autograph, in accordance with some embodiments.

FIG. 8 is a flow diagram illustrating a method for generating a non-fungible token for the digital autograph and adding the token to a block chain, in accordance with some embodiments.

FIG. 9 is a flow diagram illustrating a method for managing multiple followers requesting digital autographs from a creator, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### D. DETAILED DESCRIPTION

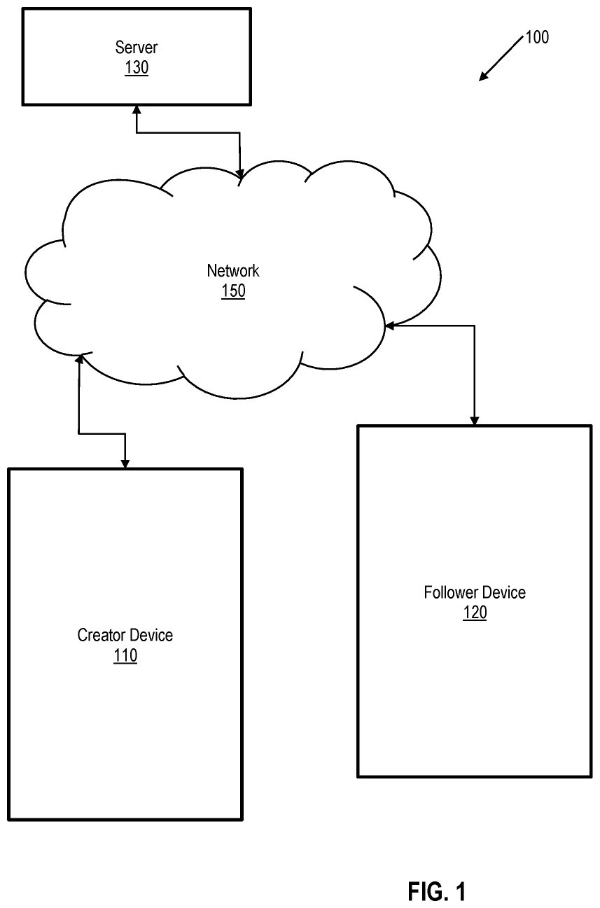

FIG. 1 is a block diagram illustrating a system configured to facilitate digital autographs, in accordance with some embodiments.

In some embodiments, system 100 may include creator device 110, follower device 120, and server 130. The three devices may be configured to communicate with each other as well as other devices, at least in part, through network 150. It should be noted that, in some embodiments, the server 130 may be optional, and the functionality of the system may be performed by the creator and follower devices.

In some embodiments, a follower through, at least in part, follower device 120 may request a digital autograph (or a customized digital media) from a creator. In response, the creator may provide the digital autograph/customized digital media to the follower using, at least in part, creator device 110.

A creator may include any person (or more generally, any entity) from whom a follower or others may be interested in receiving a digital autograph. For example, creators may be athletes, musicians, actors, writers, politicians, gamers, etc. In some embodiments, creators may include groups of people (such as a sports team, for example) as well as organizations.

A follower may be a person (or more generally, an entity) who has an interest in obtaining a digital autograph from a creator either on behalf of the follower or on behalf of others.

In some embodiments, the digital media may be selected, customized, digitally signed, and tokenized by the creator at an earlier time. The creator may then provide/sell to a follower tokenized media that had been previously created. Examples of digital media prepared at an earlier time may include photographs of the creator, screenshot of game being played by the creator, photographs of the creator in a concert, etc.

It should also be noted that both the creator and the follower may be represented by another person or an entity that may be authorized to act on their behalf, at least in terms of the requesting and/or providing digital autographs.

Creator device 110, follower device 120, and server 130, in some embodiments, may include any type computational device such as a server computer, a desktop computer, a laptop computer, a smartphone, a smartwatch, etc. Network 150 may be any local or global network that facilitates communication between these and other devices, such as the Internet, for example.

In some embodiments, creator device 110, follower device 120, and server 130 may be configured to communicate among them directly using communication protocols such as Wi-Fi, Bluetooth, sound protocols, etc. In yet other embodiments, the devices may communicate using QR codes, where information is transferred by having one device show a QR code that is scanned by another device.

In some embodiments, the near-field communication (NFC) communication protocol may be used to facilitate, at least partially, the communication between devices. In some embodiments, NFC may be utilized as an authorization/approval handshake for the autograph.

In some embodiments, the follower's device may search for evidence that the creator approved a photograph for an autograph, for example. The follower's device NFC hardware may read a predetermined secret (posted by the creator along with valid autograph signing hours, for example) to determine that the autograph was approved by the creator. In some embodiments, the customization text for an autograph may also be sent using the NFC protocol.

Numerous other communication protocols may be used for the communication between the devices.

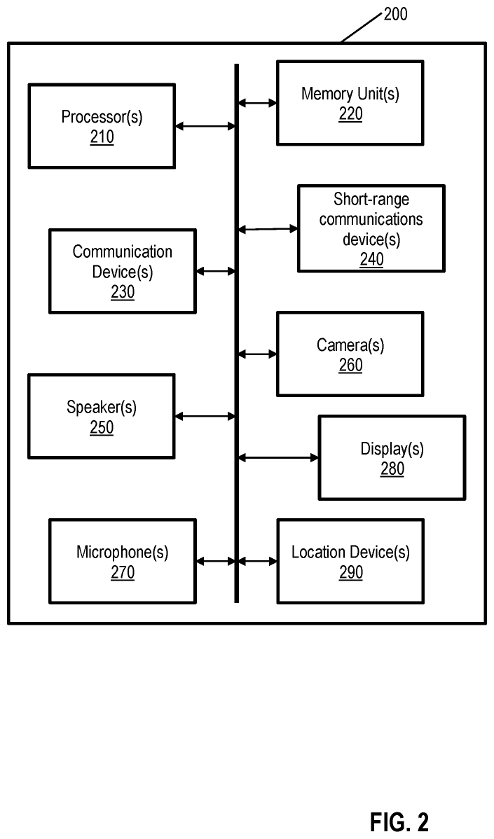

FIG. 2 is a block diagram illustrating components of a device used in digital autographs, in accordance with some embodiments.

In some embodiments, the components shown for device 200 may be the components of any device used in the signing of digital autographs, such as the creator's device, the follower's device, the server, etc.

In some embodiments, device 200 comprises one or more processors 210 and one or more memory units 220. Memory units 220 may be configured to store instructions, and processors 210 may be configured to execute these instructions to facilitate the functionality of the devices. Such functionality may include requesting/receiving and/or creating/providing digital autographs, for example. Memory units 220 may include multiple types of memory, such as volatile memory, non-volatile memory, etc.

In some embodiments, device 200 comprises one or more communication devices 230, which are configured to facilitate communications between device 200 and other devices. For example, communication devices 230 may include a Wi-Fi network adaptor, which may be configured to connect device 200 to other devices through a network such as the Internet.

In some embodiments, device 200 comprises one or more short-range communication devices 240, which are configured to facilitate communications with devices that are in the vicinity of device 200. For example, short-range communications devices 240 may include a Bluetooth network adapter for facilitating short-range communication between device 200 and other devices in the vicinity of device 200. Various other types of short-range communication devices may be used.

In some embodiments, device 200 comprises one or more speakers 250 and one or more microphones 270, which are configured, respectively, to generate sound and to receive sound from and to device 200. In some embodiments, the microphones and speakers of device 200 may be used in audio communications between device 200 and other devices located in the vicinity of device 200. In some embodiments, ultrasonic inaudible sound may be used in the communications.

In some embodiments, microphones 270 may be used to record audio that is to be used as the digital media that is to be customized into a digital autograph. For example, a follower may record part of a concert given by a singer creator. The creator may then append an audio message dedication to the recording and provide the customized audio recording to the follower as a digital autograph. In other embodiments, the creator may add a customized introduction, a customized ending, or a customized middle section to the recorded audio, for example. In some embodiments, a writer creator may add a customized dedication or generally a customized message for a follower as part of the writer's pre-recorded audiobook.

It should be noted that the digital media, in some embodiments, may be blank, such as a blank photograph, an audio track with no sound, etc. In such embodiments, the customized digital media/digital media may include the customization only.

In some embodiments, device 200 comprises one or more displays 280, which are configured to display information on device 200.

In some embodiments, device 200 comprises one or more cameras 260, which may be configured to take photographs. In some embodiments, cameras 260 may be used to take a photograph that is to be used as the digital media to be customized into a digital autograph. For example, a follower may take a photograph with the creator, the creator may append a written dedication message to the photograph, and the customized photograph may then be provided to the follower as a digital autograph.

In some embodiments, device 200 comprises one or more location devices 290, which are configured to determine the physical location of device. For example, location devices 290 may include a Global Positioning System device. In some embodiments, other type of location devices/services may also be used. In some embodiments, location information may be added to the digital media that is to be used for the digital autograph.

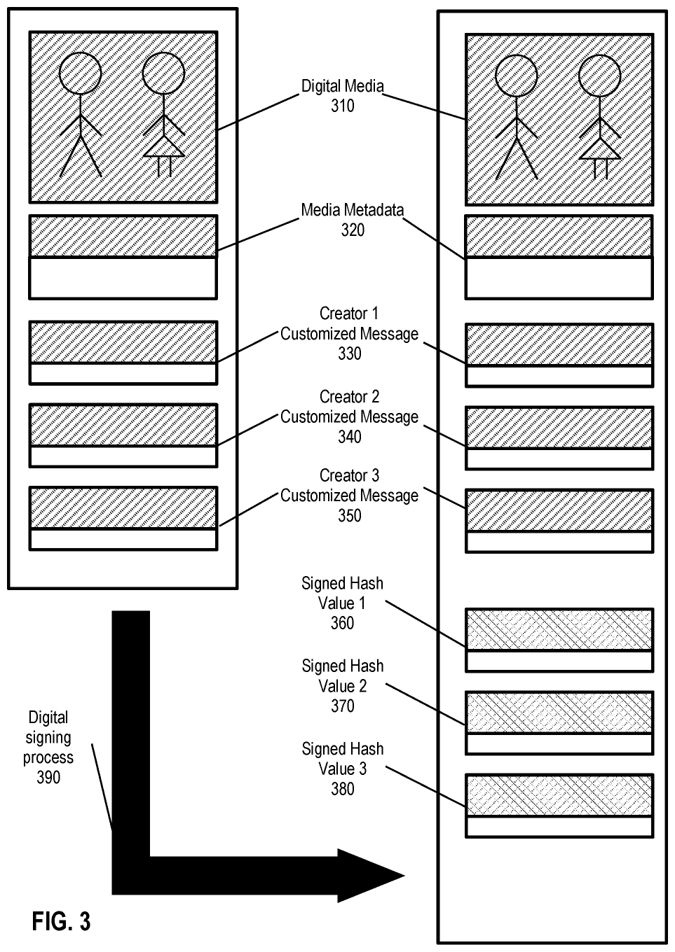

FIG. 3 is a block diagram illustrating the digital signing of an autograph by multiple creators, in accordance with some embodiments.

In some embodiments, digital media 310 represents the media that has been digitally autographed by one or more creators. For example, digital media 310 may be a photograph of the creators and the follower. Digital Media 310 may also be associated with media metadata 320, which may include information related to the digital media such as location, time created, compression algorithm, resolution, etc.

The digital media may also include customized messages from the one or more creators, such as creator 1 customized message 330, creator 2 customized message 340, and creator 3 customized message. Each creator may have created a different customized message as well as different formatting for that customized message. In some embodiments, the different messages may be associated with coordinates information that appends/places the messages over the photograph/digital media 310.

In some embodiments, only part of the data in the customized digital media/autograph may be selected to be digitally signed by the one or more creators. In the figure, the part of the data that is to be digitally signed is represented by the hatch pattern. In this example, the selected data may include the digital media, part of the metadata, and part of each of the customized messages. For example, the parts of the customized messages that contain formatting and coordinates information may be excluded from the digital signing. In such embodiments, the follower may move or change the appearance of one or more of the messages without compromising the integrity of the digital autograph as will be discussed further below.

Digital signing process 390 is then applied to the part of the data that is to be digitally signed. In some embodiments, each of the creators digitally signing the autograph generates a hash value with a one-way hashing function applied to the parts of the customized autograph that were designated to be digitally signed. Then each of the creators digitally signs each of their respective hash values using their respective private key to each generate a digitally signed hashed value. For the three creators in the current example, signed hash value 1 360, signed hash value 2 370, and signed hash value 3 380 are generated and stored with the digital autograph.

In some embodiments, in addition to the digitally signed hash values (shown here with a crosshatch pattern), each of the signed hash values may also contain an additional block of information. For example, the additional block of data may include information as to which parts of the digital autograph were used in the digital signing process.

In some embodiments, to verify the integrity of the digital autograph and/or the identify of each of the creators, a third-party may first recover each of the creator's hash values using each creator's public key respectively on each of the creator's stored digitally signed hash value. The third party may then independently reproduce the hash values by again applying the one-way hashing function to the parts of the digital autograph designated for digital signing (shown with a hatch pattern here). The reproduced hash values may be then and compared to the recovered hash values to determine tampering and authenticity of the digital autograph for each creator.

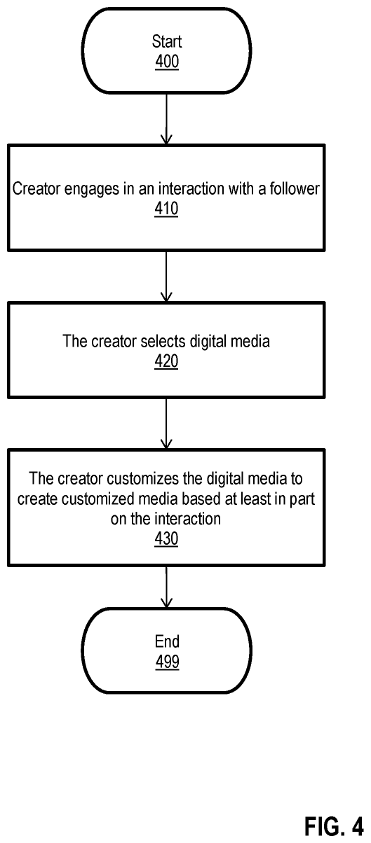

FIG. 4 is a flow diagram illustrating a method for providing digital autographs, in accordance with some embodiments.

Beginning at 400, the creator engages in an interaction with a follower at block 410. In some embodiments, an interaction may take place either online or in person. For example, the follower may attend a creator's concert, basketball game, bicycling race, car race, etc. In other embodiments, the follower may meet the creator at a place that the creator has set up for the purpose of meeting followers. In yet other embodiments, the follower may happen to meet the creator in a public restaurant.

In some embodiments, the interaction between the follower and the creator may take place online. In some embodiments, the creator may be a gamer livestreaming a game that the creator is playing and the follower watching. In other embodiments, the follower and the creator may engage in an online communication, such as a chat, voice call, or video call. In yet other embodiments, the follower may attend an online concert given by the creator.

At block 420, the creator selects the digital media that is to be customized and provided to the follower. Examples of digital media may include, photos, videos, sounds, music, etc. In some embodiments, the digital media may be provided by the follower. For example, the follower may take a photograph with the creator. Or the follower may provide to the creator a photograph from the follower's device, such as a photograph of the creator or a photograph of the follower, for example.

In other embodiments, the creator may select the digital media. In some embodiments, the creator may randomly select the digital media and/or provide autographs to randomly selected followers. For example, in a livestream by a gamer creator being watched by several followers, the creator may randomly select screenshots from the game (perhaps at random intervals), customize those screenshots, and provide them to a few, randomly selected and lucky followers.

At block 430, the creator customizes the digital media based at least on the interaction between the creator and the follower and provides the customized media to the follower, ending at 499. In some embodiments, the customization may be the annotation of a photograph with a message/dedication from the creator, such as “Thanks for being a fan!”, “SXSW 2019”, etc. In some embodiments, the customization may be a copy of the creator's physical signature.

It should be noted that, in some embodiments, the creator's device may be configured to automate at least part of the digital autograph signing process. For example, the creator may configure the creator's device to append a message, selected from a list of prepared messages, once a photograph is received and to send the customized photograph back to the follower.

In some embodiments, the creator may provide various types of collectible items as digital autographs. Collectible items may include, for example, digital versions of an album or song just released, and ebook, a clip of a goal scored by the creator, etc. In some embodiments, collectible items may also include non-fungible tokens created using such collectible items or other items, such as coupon for tickets to a performance by the creator, for example. In some embodiments, the creator may customize those items and provide those to the follower as a digital autograph.

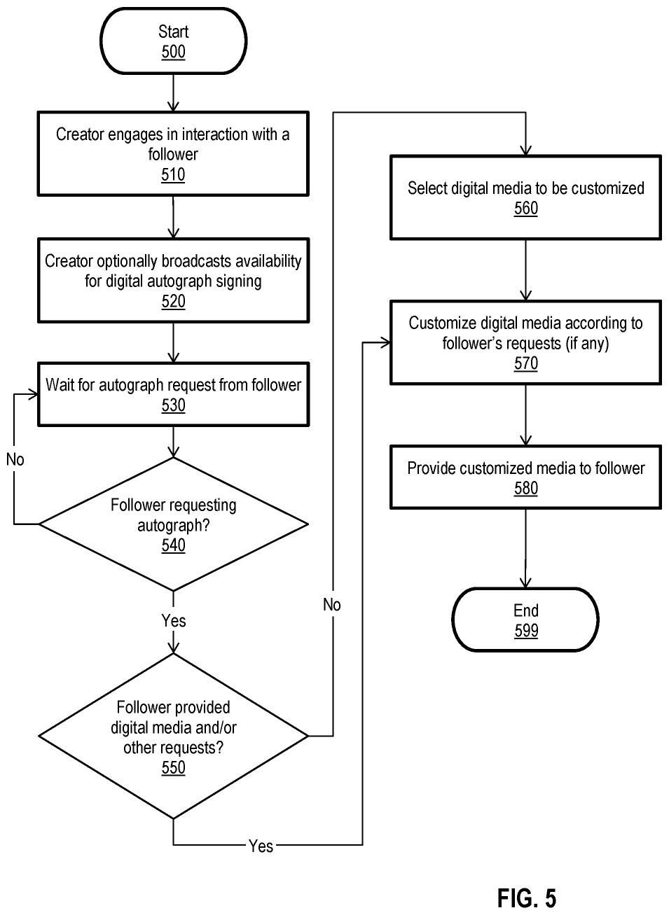

FIG. 5 is a flow diagram illustrating a creator to provide a digital autograph to a follower, in accordance with some embodiments.

Beginning at 500, the creator engages in an interaction, as was previously described, with a follower at block 510.

At block 520, the creator optionally broadcasts availability for digital autograph signing. In some embodiments, the availability may be broadcast through a network, such as the internet. In other embodiments, the availability may be broadcast through a short-range communication protocol such as Bluetooth, an audio protocol using the devices' speakers and microphones (including broadcasting in ultrasonic frequencies that would not be audible to the human ear), a visual protocol such as QR codes using a device's camera and display, etc. Examples of communication protocols include Google Nearby Messaging API, Bluetooth, Bluetooth Low Energy, Wi-Fi, near-ultrasonic audio, etc.

At block 530, the creator, through the creator's device, waits for an autograph request. At decision 540, a determination is made as to whether a request for an autograph by a follower has been made. If a request for an autograph by the follower has not yet been received, the creator continues to wait for an autograph request (at block 530).

On the other hand, if a follower requests an autograph, another determination is made, at decision 550, as to whether the follower provided digital media and/or other requests related to the autograph. If the follower has not provided digital media, at block 560, the creator selects the digital media. In some embodiments, the creator may select the digital media from a set of preselected digital media that the creator may have preselected for the purpose of signing digital autographs. For example, the preselected digital media may include a headshot of the creator, a photograph of the creator in concert, etc. As discussed above, the creator may also randomly select the digital media. The creator then proceeds to customize the media at block 570 as will be discussed below.

If the follower does provide digital media to the creator, at block 570, the creator proceeds to customize the digital media. In some embodiments, the creator may customize the digital media according to any requests provided by the follower. For example, the follower may request for the creator to append a specific dedication to the digital media. In some embodiments, if the follower did not provide any requests, the creator may select the customization. The creator may append a custom message, or the creator may select a message from a preselected list of messages. The message may further be customized, for example, in terms of font, color, etc. In some embodiments, the text of the message may also be created using a voice-to-text application.

At block 580, the customized digital media is provided to the follower, ending at 599.

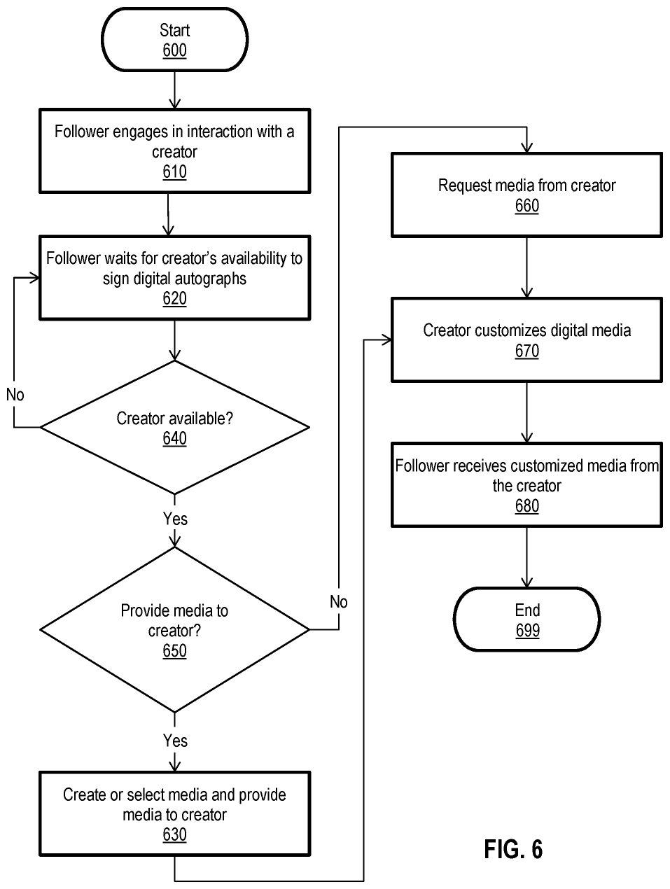

FIG. 6 is a flow diagram illustrating a method for a follower to request an autograph from a creator, in accordance with some embodiments.

Beginning at 600, the follower engages in an interaction, as described above, with the creator at block 610. At block 620, the follower waits for creator's availability to sign autographs. In some embodiments, the follower's device may detect availability for signing autographs through a communication with the creator's device as was described above.

A determination is then made, at decision 640, as to whether the creator is available for digital autograph signing. If the creator is not available, the follower continues to wait for the creator's availability at block 620.

On the other hand, if the creator is available, another determination is made, at decision 650, as to whether the follower will be providing digital media for the digital autograph. If the follower will not be providing the digital media, at block 660, the follower requests that the creator provide the digital media. The creator then proceeds to customize the digital media at block 670.

If the follower provides the digital media to the creator, the follower generates the digital media at block 630 as was described above.

At block 670, the creator customizes the digital media as was described above. At block 680, the follower receives the customized digital media from the creator, ending at 599.

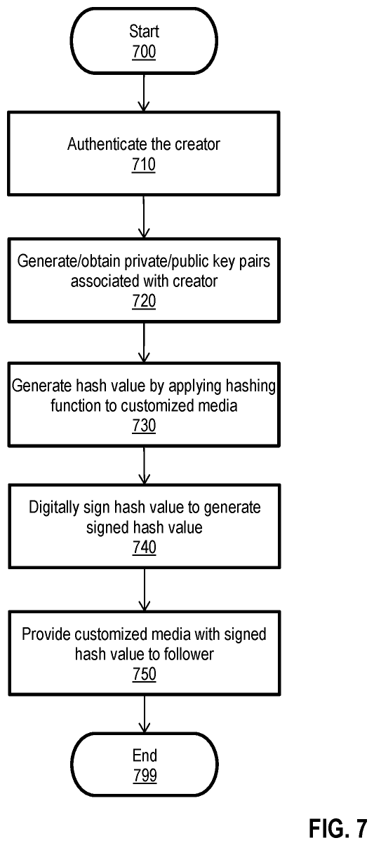

FIG. 7 is a flow diagram illustrating a method for a creator to digitally sign a digital autograph, in accordance with some embodiments.

Beginning at 700, the identity of the creator is authenticated at block 710. In some embodiments, the identity of the creator may be authenticated by an identity provider using, for example, protocols such as Oauth and a corresponding login. Services such as Twitter, Facebook, Google, etc. may be used to establish the identity of the creator. In other embodiments, the identity of the creator may be established by a self-sovereign identity solution using an identity meta system.

At block 720, a private/public encryption key pair may be obtained or generated in association with the creator's authenticated identity. The key pair may be generated and kept on an external server, and as a backup, the creator's key pair may be stored on the server in addition to being provided to the creator. In some embodiments, the key pair may be stored in a secure storage area on the creator's device.

At block 730, a hash value is generated by applying a one-way hashing function to the customized media generated by the creator. In some embodiments, the hash value may be recreated from the customized media at a later time by a third party and compared to the original hash value to determine, for example, the integrity of the customized media/digital autograph. In other embodiments, various other methods may be used to protect the integrity of the customized digital media.

In some embodiments, the hashing function may be selectively applied to a subset of the customized media only. For example, the follower may wish to retain the right to move part of an appended message on a photograph to a different location on the photograph, change the formatting of the appended message, or generally make other changes to the customized media. Other examples of parts excluded from the hashing function may include location coordinates, other formatting, other media metadata, etc.

At block 740, the hash value is digitally signed (encrypted) using the creator's private key to create a signed hash value. At a later time, an interested third party may use the creator's public key to recover the hash value. The hash value may then be compared with a hash value obtained by applying the hashing function to the customized media to determine that the customized media was signed by the creator and that the customized media has been not been altered (tampered with).

In some embodiments, a hashing function, such as SHA-265, may be used to generate the hash value, followed by an asymmetric cypher, such as RSA, for digitally signing the hash value. It should be noted that the digital signing procedure may be performed by the creator's device or it may be performed on an external server on the creator's behalf.

In some embodiments, a private/public key pair may also be created and associated with the follower. The digital signature of the follower (using the follower's private key) may be then applied to the hash value in addition to the digital signature of the creator being applied.

At block 750, the digitally signed hash value as well as the customized digital media are provided to the follower, ending at 799.

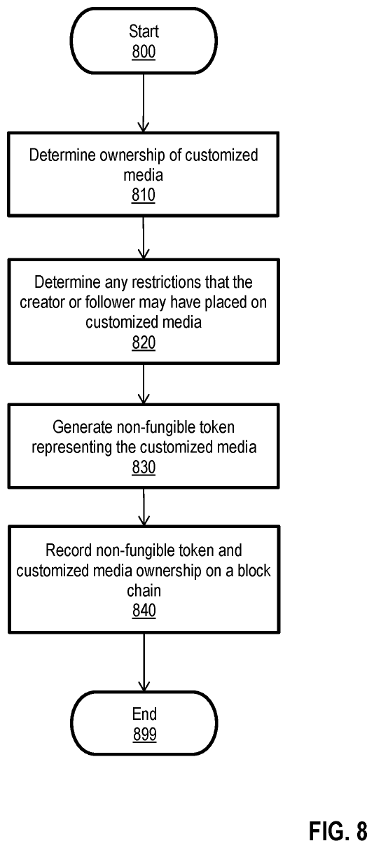

FIG. 8 is a flow diagram illustrating a method for generating a non-fungible token for the digital autograph and adding the token to a block chain, in accordance with some embodiments.

Beginning at 800, the ownership of the customized media is established at block 810 as was described above.

At block 820, any restrictions that the creator or the follower may have placed on the customized media are determined. Examples of such restrictions include: sale restrictions in cases where revenue sharing with the creator is desired upon sale or transfer of the token; rules for sharing royalty payments with the creator; terms of use restrictions; the payment address for the creator's digital wallet (or assigned representative's wallet), etc.

At block 830, a non-fungible token representing the customized media/digitally signed autograph is created. In some embodiments, the non-fungible token may be created to create and uniqueness of the customized media and to record ownership of the customized media. The autograph may be restricted to a single copy or the autograph may be restricted to a higher number of copies. The higher number of copies may, in some embodiments, be sequentially numbered (1 of 3, 2 of 3, 3 of 3, for example). In embodiments where a certain number of copies of the autograph is permitted, an equal number of tokens may be created, one for each authorized copy of the autograph. In some embodiments, token implementations, such ERC-721 tokens or ERC-1155 may be used to create the token. In some embodiments, the token may also include the restrictions requested by the creator and/or the follower.

At block 840, the non-fungible token may be recorded on a block chain, ending at 899. In some embodiments, recording the token on a block chain facilitates proof of ownership of the underlying customized media as well as enforcement of the additional restrictions imposed on the customized media. In some embodiments, ownership for the non-fungible may be transferred to follower by transferring to the follower's digital wallet, for example. In some embodiments, each time ownership changes for a copy of the autograph, the verified transaction may be recorded on the block chain.

In some embodiments, the non-fungible token(s) (NFT) may be listed for sale on an NFT marketplace. In addition, the creator may reserve a subset of the copies (where multiple copies are authorized) of the NFTs, for example, for a future sale.

In some embodiments, alternative recording methods may be used for the customized media and the ownership of the customized media and the restrictions imposed on the customized media. For example, a recording service may be implemented on an external server, tracking the customized media/autographs, the ownership of the customized media, as well as any restrictions that either the creator or the follower may have placed on the customized media.

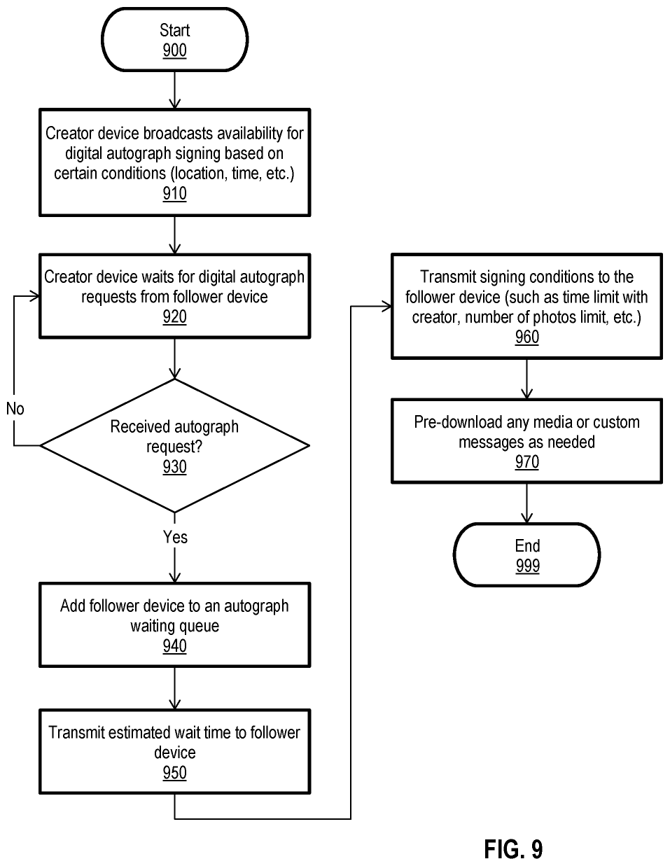

FIG. 9 is a flow diagram illustrating a method for managing multiple followers requesting digital autographs from a creator, in accordance with some embodiments.

Beginning at 900, the creator device may broadcast availability for digital autograph signing based on certain conditions at block 910. In some embodiments, availability may be broadcast using various types of communication protocols or short-range communication protocols, as was discussed above. In some embodiments, availability may be determined based on various conditions. For example, availability may be determined based on a preset schedule. In other examples, availability may be determined based on preset detected location and/or time. In yet other embodiments, a creator may manually enable availability. In some embodiments, the follower device may present a customized map of events showing which stage/location the creator may be performing and when based at least in part on the creator device broadcasting availability.

At block 920, the creator device waits for a digital autograph request from a follower device. At decision 930, a determination is made as to whether a request for autograph has been received. If a request has not yet been received, the creator device continues to wait for an autograph request at block 920. On the other hand, if a request for an autograph has been received, at block 940, the follower device is added to an autograph waiting queue.

At block 950, an estimated wait time for obtaining the digital autograph (based on where the follower is in the waiting queue) is provided to the follower device, and at block 960, additional autograph signing conditions are provided to the follower device. Autograph signing conditions may include time limits (such as how much time a follower may spend with the creator during the autograph signing process), number of photographs that follower may be allowed to take with the creator, and other conditions that would generally help manage the autograph process for the creator and the followers.

At block 970, media and custom messages may be downloaded to the follower's or creator's devices while the follower is waiting for the autograph, ending at 999. Generally, any other process that may expedite the autograph signing process may be performed while the follower is waiting in the waiting queue for a digital autograph.

It is understood that the implementation of other variations and modifications of the present invention in its various aspects will be apparent to those of ordinary skill in the art and that the invention is not limited by the specific embodiments described. It is therefore contemplated to cover by the present invention any and all modifications, variations or equivalents that fall within the spirit and scope of the basic underlying principles disclosed and claimed herein.

One or more embodiments of the invention are described above. It should be noted that these and any other embodiments are exemplary and are intended to be illustrative of the invention rather than limiting. While the invention is widely applicable to various types of systems, a skilled person will recognize that it is impossible to include all the possible embodiments and contexts of the invention in this disclosure. Upon reading this disclosure, many alternative embodiments of the present invention will be apparent to persons of ordinary skill in the art.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all the claims. As used herein, the terms “comprises,” “comprising,” or any other variations thereof, are intended to be interpreted as non-exclusively including the elements or limitations that follow those terms. Accordingly, a system, method, or other embodiment that comprises a set of elements is not limited to only those elements and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions, and improvements to the embodiments described above are possible. It is contemplated that these variations, modifications, additions, and improvements fall within the scope of the invention as detailed within the following claims.

1. A computer-implemented method comprising:
determining a location of a creator's creator computing device;
determining a location of a follower's follower computing device;
customizing digital media to create customized digital media, based at least in part on an in-person interaction between the creator and the follower;
wherein the in-person interaction is based at least upon the location of the creator computing device and the location of the follower computing device, wherein the customizing comprises including the location of the creator computing device and the location of the follower computing device.

2. The method of claim 1, comprising the creator digitally signing at least a portion of the customized digital media, wherein the digitally signing comprises:
creating a digital hash using at least a portion of the customized digital media;
digitally signing the digital hash using a private key of the creator, wherein the private key is from a private-public key pair of the creator, wherein the private-public key pair comprises the private key and a public key; and
including the signed digital hash with the customized digital media.

3. The method of claim 2, comprising authenticating the identity of the creator at least in part by one or more authentication services.

4. The method of claim 3, comprising providing authentication proof that the creator customized the customized media based at least upon the creator digitally signing at least part of the customized media and using the creator's public key.

5. The method of claim 4, comprising restricting a number of authorized copies of the customized digital media and providing authentication proof of the creator creating the customized digital media based at least upon creating a non-fungible token and adding the non-fungible token to a block chain.

6. The method of claim 1, comprising providing the customized digital media to the follower.

7. The method of claim 1, comprising the creator broadcasting times and/or locations of availability, and the follower requesting the customized media based at least in part on the creator broadcasting the availability.

8. A system comprising:
one or more processing units; and
one or more memory units coupled to the one or more processing units,
wherein the one or more memory units are configured to store instructions,
wherein the one or more processing units are configured to execute the instructions causing the system to perform operations comprising:
determining a location of a creator's creator computing device;
determining a location of a follower's follower computing device;
customizing digital media to create customized digital media, based at least in part on an in-person interaction between the creator and the follower;
wherein the in-person interaction is based at least upon the location of the creator computing device and the location of the follower computing device,
wherein the customizing comprises including the location of the creator computing device and the location of the follower computing device.

9. The system of claim 8, the operations comprising the creator digitally signing at least a portion of the customized digital media, wherein the digitally signing comprises:
creating a digital hash using at least a portion of the customized digital media;
digitally signing the digital hash using a private key of the creator, wherein the private key is from a private-public key pair of the creator, wherein the private-public key pair comprises the private key and a public key; and
including the signed digital hash with the customized digital media.

10. The system of claim 9, the operations comprising authenticating the identity of the creator at least in part by one or more authentication services.

11. The system of claim 10, the operations comprising providing authentication proof that the creator customized the customized media based at least upon the creator digitally signing at least part of the customized media and using the creator's public key.

12. The system of claim 11, the operations comprising restricting a number of authorized copies of the customized digital media and providing authentication proof of the creator creating the customized digital media based at least upon creating a non-fungible token and adding the non-fungible token to a block chain.

13. The system of claim 8, the operations comprising providing the customized digital media to the follower.

14. The system of claim 8, the operations comprising the creator broadcasting times and/or locations of availability, and the follower requesting the customized media based at least in part on the creator broadcasting the availability.

15. At least one non-transitory, machine-accessible storage medium having instructions stored thereon, wherein the instructions are configured, when executed on a machine, to cause the machine to perform operations comprising:
determining a location of a creator's creator computing device;
determining a location of a follower's follower computing device;
customizing digital media to create customized digital media, based at least in part on an in-person interaction between the creator and the follower;
wherein the in-person interaction is based at least upon the location of the creator computing device and the location of the follower computing device,
wherein the customizing comprises including the location of the creator computing device and the location of the follower computing device.

16. The storage medium of claim 15, the operations comprising the creator digitally signing at least a portion of the customized digital media, wherein the digitally signing comprises:
creating a digital hash using at least a portion of the customized digital media;
digitally signing the digital hash using a private key of the creator, wherein the private key is from a private-public key pair of the creator, wherein the private-public key pair comprises the private key and a public key; and
including the signed digital hash with the customized digital media.

17. The storage medium of claim 16, the operations comprising authenticating the identity of the creator at least in part by one or more authentication services.

18. The storage medium of claim 17, the operations comprising providing authentication proof that the creator customized the customized media based at least upon the creator digitally signing at least part of the customized media and using the creator's public key.

19. The storage medium of claim 18, the operations comprising restricting a number of authorized copies of the customized digital media and providing authentication proof of the creator creating the customized digital media based at least upon creating a non-fungible token and adding the non-fungible token to a block chain.

20. The storage medium of claim 15, the operations comprising the creator broadcasting times and/or locations of availability, and the follower requesting the customized media based at least in part on the creator broadcasting the availability.
